(19) United States
(12) Patent Application Publication
(10) Pub. No.: US 2026/0273643 A1
(43) Pub. Date: Sep. 17, 2026

(54) ADDITIVE MANUFACTURING OF PRESSURE CONTAINMENT VESSELS

(71) Applicant: FMC TECHNOLOGIES DO BRASIL LTDA, Rio de Janeiro (BR)

(72) Inventors: Marcos Cantu Mannarino, Rio de Janeiro (BR); Victor Hugo Pereira Moraes e Oliveira, Rio de Janeiro (BR); Guilherme Sousa Moura, Rio de Janeiro (BR); Sara Fonseca da Silva, Niteroi (BR); Thiago Escossia da Fonseca, Rio de Janeiro (BR)

(21) Appl. No.: 19/081,354

(22) Filed: Mar. 17, 2025

(51) Int. Cl. B23K 9/04; B33Y 10/00; B33Y 80/00; F16K 27/00

(52) U.S. Cl. CPC B23K 9/044; F16K 27/00; B33Y 10/00; B33Y 80/00

(57) ABSTRACT

Systems and methods for additive manufacturing of pressure containment vessels in undersea oil and gas systems are disclosed. A primary pressure vessel comprising at a primary fluid conduit and valves configured to control a flow of fluid in the primary pressure vessel may be provided. The primary pressure vessel may be operable as a primary valve block in an undersea oil and gas system. Furthermore, an additively manufactured secondary pressure vessel can be integrally coupled to the primary pressure vessel. The secondary pressure vessel includes a secondary conduit in fluid communication with the primary fluid conduit and valve cavities configured to house secondary valves for controlling the flow of the fluid through the secondary pressure vessel. The secondary pressure vessel may be operable as an external valve block integrally coupled to the primary pressure vessel.

### BACKGROUND

### 1. Field

Embodiments of the current disclosure relate to additive manufacturing of components of oil and gas well systems. More specifically, embodiments of the current disclosure relate to additive manufacturing of pressure vessels for undersea oil and gas wells.

### 2. Related Art

Typically, pressure containment structures in the undersea oil and gas industry, such as valve blocks, comprise various conduits and valves to channel fluid between various regions of oil and gas systems. Furthermore, primary valve blocks typically comprise various externally connected valve blocks for controlling fluids for oil and gas production. The valve blocks utilize metal cast or forged components that must be assembled to form the pressure containment systems. As such, current systems require many components that must be assembled requiring extensive labor with costs. Furthermore, the assembly of the components provides points that can be weak and/or cause leakage of the fluid under pressure inside the pressure containment vessels. Furthermore, typical connection points between components of undersea oil and gas wells, particularly pressure vessels, must be cladded, or prepared for connection to prevent erosion, corrosion, and damage. Current methods are limited by linear drilling, which limits fluid flow characteristics.

What is needed are pressure containment systems with reduced complexity, reduced part quantity, reduced fail and leak points, reduced labor, and reduced cost that provide fast and cost-effective customization and manufacturing. Furthermore, what is needed are systems and methods of additively manufacturing the pressure containment vessels including standard, variable, and irregularly shaped conduits for providing fluid flow through the pressure containment vessels. The AM methods described herein provide short fluid path and simple manufacturing that reduces secondary pressure vessel designs to only necessary components.

### SUMMARY

Embodiments of the current disclosure solve the above-described problems and provide a distinct advance in the art by providing systems and methods of additively manufacturing pressure containment vessels for subsea oil and gas systems.

An embodiment of the current disclosure comprises a pressure containment vessel of an oil and gas well. The pressure containment vessel comprises a primary pressure vessel. The primary pressure vessel comprises at least one primary fluid conduit and one or more valves configured to control a flow of fluid in the primary pressure vessel. The pressure containment vessel further comprises a secondary pressure vessel integrally coupled to the primary pressure vessel, wherein the secondary pressure vessel is formed by additive manufacturing, and wherein the secondary pressure vessel comprises at least one secondary fluid conduit in fluid communication with the at least one primary fluid conduit.

An embodiment of the current disclosure comprises a method of additively manufacturing a pressure containment vessel for an undersea oil and gas well. The method comprises providing a primary pressure vessel in an additive manufacturing device, wherein the primary pressure vessel comprises primary fluid conduits exposed to a surface of the primary pressure vessel, providing a material to the surface of the primary pressure vessel, melting the material with the surface to generate a first layer of a secondary pressure vessel integrally formed with the primary pressure vessel, and generating subsequent layers to create the secondary pressure vessel including secondary fluid conduits in fluid communication with the primary fluid conduits.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an embodiment of additive manufacturing a pressure containment vessel;

FIG. 2 depicts an exemplary primary valve block with an attached wing block of an undersea oil and gas well tree;

FIG. 3A depicts interior components of the wing block;

FIG. 3B depicts a schematic of the wing block;

FIGS. 4A and 4B depict an embodiment of a secondary pressure vessel;

FIG. 5A-5C depict an exemplary embodiment of additive manufacture of an order-customized secondary pressure vessel on the primary pressure vessel;

FIG. 6A-6B depict embodiments of the secondary pressure vessel integrally coupled to primary pressure vessel;

FIG. 6C depicts exemplary conduits of an embodiment of secondary pressure vessel; and

FIG. 7 depicts an exemplary process of integrally forming secondary pressure vessel with primary pressure vessel.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the current technology can include a variety of combinations and/or integrations of the embodiments described herein.

Generally, embodiments of the current disclosure provide systems and methods for additively manufacturing secondary pressure vessels and integrally coupling the secondary pressure vessels to primary pressure vessels in the undersea oil and gas industry. The term “pressure vessel” is used throughout. It should be noted that the term “pressure vessel” as used herein may be any component associated with an undersea tree, manifold (e.g., Pipeline End Manifold PLEM), Pipeline End Termination (PLET), primary flow control block, secondary flow control blocks, chemical injection tree (CIT) blocks, blind flanges, and any other standard flow control components in the industry. The term does not require that the vessel be under pressure but that the vessel comprise one or more conduits operable to control the flow of fluids. The industry in which the pressure vessel is operable is the oil and gas industry and the pressure vessels described herein are operable on any oil and gas system, including at least undersea systems.

The pressure vessels describe herein may be created using additive manufacturing techniques. Direct Energy Deposition (DED, e.g., wire arc additive manufacturing) is described herein; however, various other techniques of additive manufacturing may be used. In some embodiments, the secondary pressure vessels are created by providing layer upon layer of material creating the geometry of the secondary pressure vessel. In some embodiments, secondary pressure vessel comprises various conduits in fluid communication with linear and nonlinear conduits of the primary pressure vessel describe in detail below. Furthermore, secondary pressure vessel may include valve cavities configured to house valves for controlling the flow of the fluid through secondary pressure vessel.

In some embodiments, secondary pressure vessel is integrally coupled to primary pressure vessel. As described in embodiments herein, integrally coupled to can be welded to or formed with. For example, secondary pressure vessel may be created by additive manufacturing then welded to primary pressure vessel. Alternatively, or similarly, secondary pressure vessel may be additively manufactured on a surface of primary pressure vessel integrally forming secondary pressure vessel with the surface of primary pressure vessel. The techniques described below eliminate various components of currently used pressure vessels reducing complexity, time, weight, size, and cost.

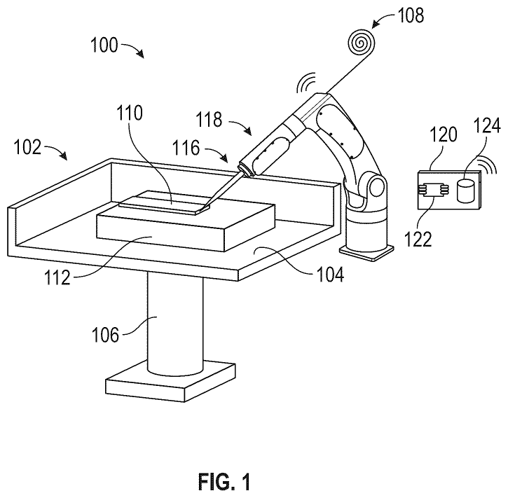

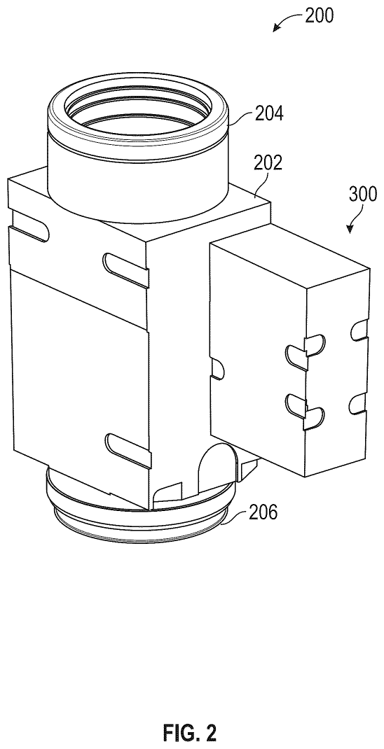

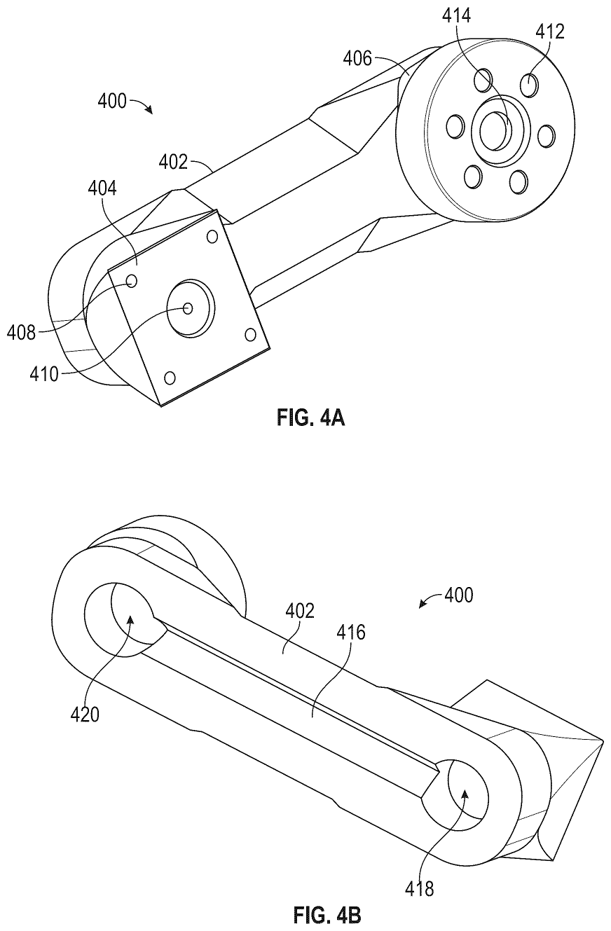

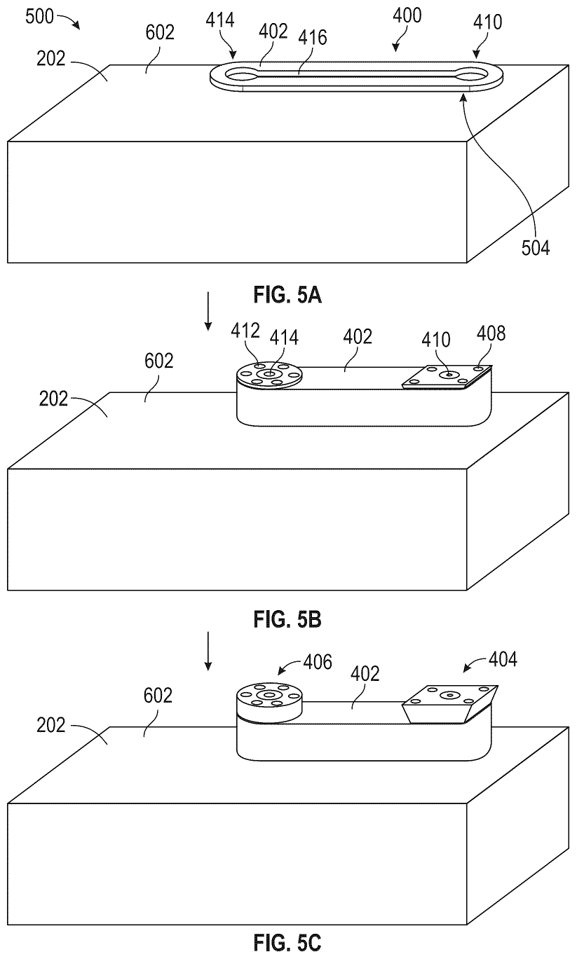

FIG. 1 depicts additive manufacturing (AM) system 100, which, in some embodiments, may be a DED system. Here, DED system and process is shown and described as wire arc additive manufacturing; however, any AM process can be utilized and DED is exemplary only. In some embodiments, AM system 100 is operable to manufacture parts by the AM process described below. AM system 100 may comprise AM table 102. In some embodiments, AM table 102 comprises build platform 104 and build platform piston 106 operable to raise, lower, tilt, and rotate build platform 104. Material 108 (e.g., feedstock, wire, filaments, powder, and the like) may be deposited on build platform 104 for the manufacturing of secondary part 110 (e.g., secondary pressure vessel 400 illustrated in FIG. 4A-4B, 5A-5C, and 6A-6B). In some embodiments, primary part 112 (e.g., primary pressure vessel 202 illustrated in FIG. 2 and 5A-5C) may be provided below secondary part 110, and secondary part 110 may be manufactured on primary part 112. In some embodiments, primary part 112 may not be present and manufacturing of secondary part 110 may be performed independently of primary part 112.

AM system 100 may be operable to manufacture primary part 112 and secondary part 110. In some embodiments, platform piston 106 lowers/raises build platform 104. In some embodiments, nozzle 116 is operational under instructions from controller 120 and/or manual operation to provide material 108 to build platform 104. As illustrated in FIG. 1, secondary part 110 is deposited on and integrally coupled to primary part 112. Nozzle 116 may be operated to provide material 108 at a designated location on parts 110/112 based on stored instructions described below. Nozzle 116 moves along a surface of parts 110/112 melting material 108 and the previous layer, or surface, of parts 110/112 to generate new layers of parts 110/112. The process may then be repeated until the final geometry of parts 110/112 is complete.

The AM process described herein may include any known or as of yet developed AM process. Though DED is described herein, other manufacturing methods including VAT photopolymerization, material jetting, binder jetting, material extrusion, sheet lamination, and any other additive manufacturing methods may be used. For example, direct metal laser sintering (DMLS), electron beam melting (EBM), selective heat sintering (SHS), selective laser melting (SLM), selective laser sintering (SLS), laser powder ded fusion (LPBF) and any other method of additive manufacturing may be used, and any known technique may be used corresponding to the known manufacturing processes.

In some embodiments, material 108 may be any type of material that may be melted by heating element 118 of nozzle 116 and provide the necessary characteristics for parts 110/112. In some embodiments, material 108 may include titanium, steel, stainless steel, aluminum, copper, cobalt chrome, nickel, gold, platinum, or any other metal or metal alloy, or mixtures thereof. Furthermore, material 108 is only exemplary and any material may be used to manufacture parts 110/112, including, for example, polymers and composite materials. Material 108 can be in the form of powder, wire, filaments, and any other material that may be used in the AM processes.

AM system 100, in some embodiments, may comprise controller 120, which may comprise one or more processors 122 and memory 124 to control the various components of AM system 100. Controller 120 may comprise one or more non-transitory computer-readable media storing computer-executable instructions that, when executed by the at least one processor 122, perform the processes described herein. Controller 120 may be in communication with and, in some cases, control any components of AM system 100 including build platform 104, build platform piston 106, dispenser platform piston 114, nozzle 116, and/or any other components that may be in communication with controller 120. In some embodiments, controller 120 may comprise the at least one processor 122, memory 124, communication elements, and any other general computing components.

In some embodiments, controller 120 comprises computer-readable media including both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Generally, a data store comprising memory 124 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer, accessible on a local network, or remotely accessible over public Internet.

The AM process described herein may be applied to primary part 112 and/or secondary part 110 together or independently. For example, primary part 112 (e.g., primary pressure vessel 202) and secondary part 110 (e.g., secondary pressure vessel 400) may be manufactured by the AM system 100 or any other system separately then welded together by AM system 100. In some embodiments, primary part 112 may be manufactured by alternative methods such as, for example, casting, molding, forging, extruding, and the like. Primary part 112 may then be provided on build platform 104 and secondary part 110 may be welded thereto. In some embodiments, primary part 112 may be provided on build platform 104 and secondary part 110 may be manufactured onto primary part 112 as described in embodiments below.

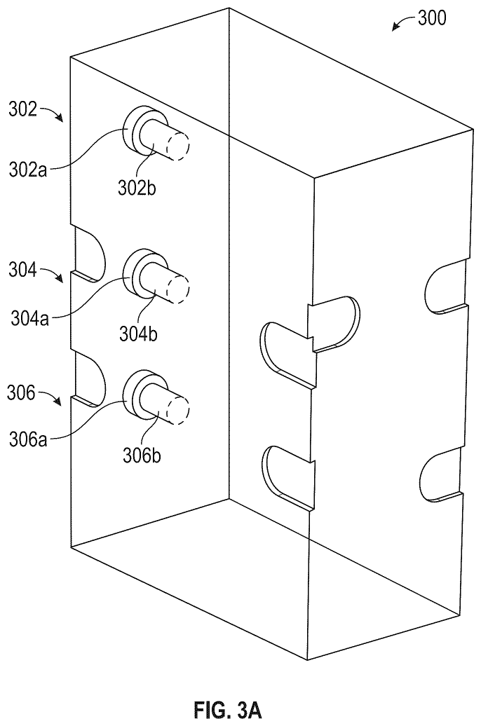

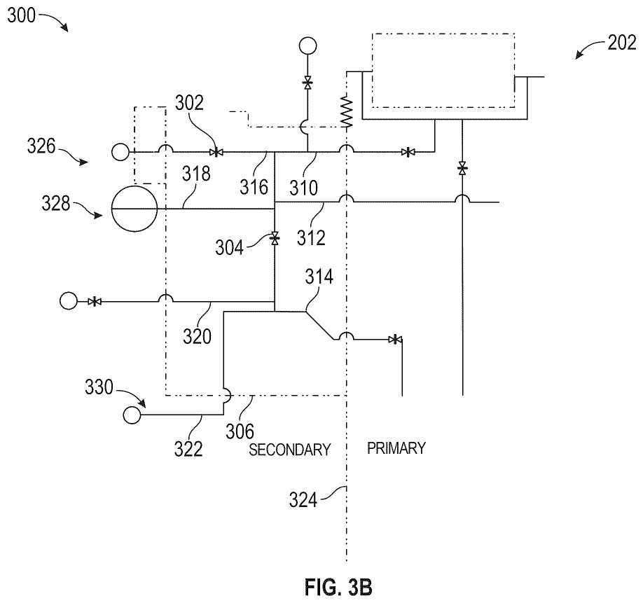

FIG. 2 depicts an exemplary embodiment of a primary valve assembly 200 of an undersea oil and gas system. Here, pressure system comprises primary pressure vessel 202, which, in this example is a primary valve block. Furthermore, pressure system comprises wing block 300 (depicted in detail in FIG. 3A-3B). Here, primary pressure vessel 202 is a valve block in the oil and gas industry; however, it should be noted that primary valve block could represent any pressure vessel comprising conduits, valve spaces, valves, and any other components of typical pressure vessels in the oil and gas industry. Primary pressure vessel 202 is a forged control valve block and, as illustrated, comprises upper connector 204, which can be configured to couple to the production line. Furthermore, primary pressure vessel 202 illustrated here, comprises lower connector 206, which may be configured to couple to lower piping and components of the oil and gas well such as, for example, a tubing hanger. Primary pressure vessel 202 may be any standard primary valve block in the oil and gas industry that may be coupled to a secondary part and serve any standard function in the industry.

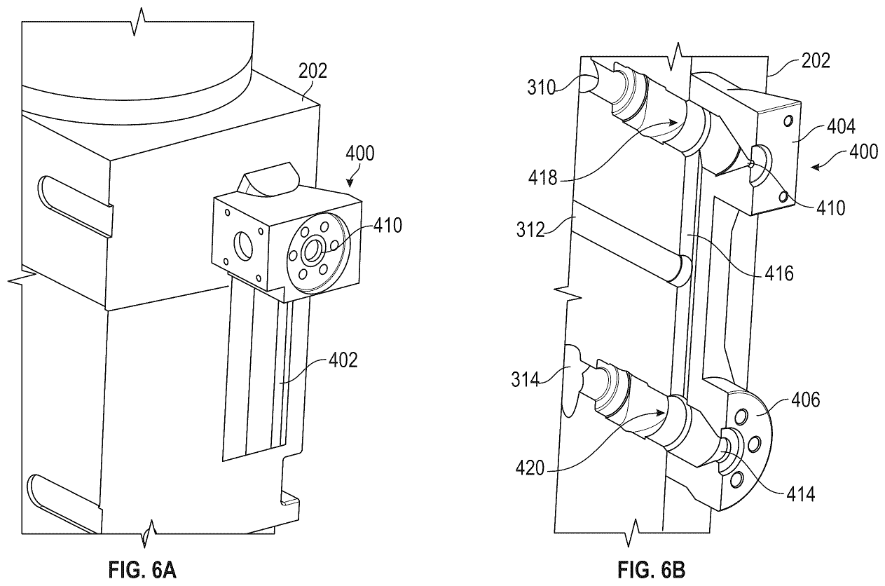

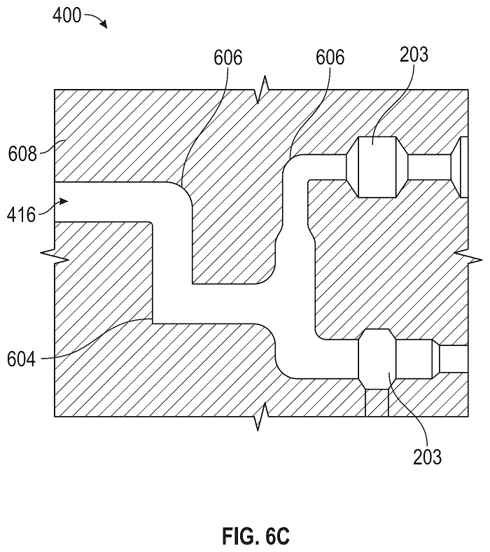

Primary pressure vessel 202 may be configured to be coupled to an undersea wellhead and tubing hanger and may comprise various interior valves (e.g., annulus valves, production valves, and the like) providing conduits to couple to various exterior valves (e.g., annulus wing valves, production wing valves, crossover valves, and the like). Primary pressure vessel 202 may be configured to couple to various valve blocks to control the flow of fluids from the well and the various annuluses. As such, various primary conduits (e.g., primary conduits 310, 312, and 314 illustrated in FIGS. 3B and 6B) may be provided throughout primary pressure vessel 202. The various primary conduits may be in fluid communication with various secondary conduits in secondary pressure system such as, for example, wing block 300 (FIG. 3A-3B) coupled to an exterior of primary pressure vessel 202. For example, the various conduits of primary pressure vessel 202 may be configured to align with conduits of the wing block 300 and a production wing block (not shown) for controlling the flow of the annulus fluid and the production fluid.

FIG. 3A depicts an exemplary wing block 300 that may be used in the undersea oil and gas industry. Here, wing block 300 may be configured to couple to primary pressure vessel 202 (e.g., primary valve block) aligning various annulus conduits of wing block 300 with primary conduits of primary pressure vessel 202. Here, wing block 300 comprises various features that create component complexity, assembly complexity, and potential leak and failure points. For example, various interfaces comprising various components (302a, 304a, 306a), such as flanges, fasteners, gaskets, and geometry for fasteners and gaskets that add complexity and potential failure points. Furthermore, wing block conduits 302b, 304b, 306b, comprise exemplary inlets that may be connected to one another and/or various other conduits, components, and outlets to control the flow of fluid through wing block 300. Furthermore, to provide corrosion resistance and reduce deterioration on the surfaces of primary pressure vessel 202 and wing block 300, protective materials such as, for example, stainless steel, nickel, titanium, aluminum, and corrosion resistant alloys known as cladding may be added. The manufacturing processes and systems described herein eliminate the need for some of these features. Specifically, because primary pressure vessel 202 and secondary pressure vessel 400, described below, are integrally coupled, cladding is not necessary and can be omitted from the processes and systems described herein.

FIG. 3B illustrates an exemplary schematic of the wing block 300 shown in FIG. 3A. Embodiments herein, provide for additive manufacturing processes for creating parts that reduces the complexity and quantity of existing parts and reduce manhours required in installing those parts. Furthermore, reduction in parts and assembly leads to reduced failure points and reduced time and cost. As such, various valves and parts of wing block 300 can be removed by utilizing additive manufacturing to produce secondary pressure vessel 400, which, in some embodiments, replaces wing block 300 as well as any other components that may be coupled to primary pressure vessel 202.

In some embodiments, wing block 300 can be replaced by secondary pressure vessel 400 (FIG. 4A-4B) without losing functionality. Furthermore, various components may be eliminated decreasing complexity, size, weight, assembly, labor, materials, components, and time as described above. FIG. 3B depicts an exemplary schematic of some of the innerworkings of primary valve assembly 200 and wing block 300 separated by interconnecting line 324. Here, primary pressure vessel 202 comprises primary conduits 310, 312, 314, referenced herein as first primary conduit 310, second primary conduit 312, and third primary conduit 314. It should be noted that three primary conduits are exemplary, and any number of conduits may be present. Primary conduits 310, 312, 314 provide flow of production and annulus fluids through primary pressure vessel 202. Furthermore, primary conduits 310, 312, 314 comprise various conduit valve cavities housing primary valves (e.g., air sequence valves, pressure safety valves, control valves, and the like). The primary valves may be controlled by electromechanical actuators by manual operation or automatically based on the state of oil and gas system and/or fluid and flow characteristics of the fluid in primary conduits 310, 312, 314. As such, flow can be controlled between primary pressure vessel 202 and wing block 300.

Furthermore, various components are required for wing block 300 to perform the desired function. Wing block 300 comprises wing conduits 316, 318, 320, 322 (in fluid communication with primary conduits 310, 312, 314) referenced herein as first wing conduit 316, second wing conduit 318, third wing conduit 320, and further wing conduit. Furthermore, wing block 300 requires various wing block interfaces 302, 304, 306 comprising various control valves in fluid communication with primary conduits 310, 312, 314 to control the flow between primary pressure vessel 202 and wing block 300. Furthermore, additional components of wing block 300 may be required for operation. For example, various valves 326, sensors 328, and connectors 330 to other components may be provided by wing block 300. By integrally coupling secondary pressure vessel 400 with the surface of primary pressure vessel 202, wing block interfaces 302, 304, and 306 comprising the valves described above as well various other valves 326, sensors 328, and connectors 330 may affectively eliminate excess waste. As complexity, size, weight, assembly, labor, materials, components, and time are reduced, waste is also reduced. In some embodiments, the simplified configurations of secondary pressure vessel 400 created by the AM processes described herein result in a weight reduction between wing block 300 and secondary pressure vessel 400 of approximately 70% of standard wing block weight. Furthermore, when replacing secondary blocks (annulus wing block, production wing block, injection valves, and the like) with secondary pressure vessels 400 describe herein, an overall weight savings of 10-15% may be had for the entire primary valve assembly 200.

FIG. 4A-4B depict secondary pressure vessel 400. As described in detail below, because secondary pressure vessel 400 is integrally coupled to primary pressure vessel 202, the above-described interface between each primary conduit of primary pressure vessel 202 and each secondary conduit of secondary pressure vessel 400 can be removed. Removal of the interface means removal of the various exemplary valves and gaskets described in regard to wing block 300 above. As such, complexity, failure probability, and time and cost in assembly and manufacturing are reduced. Furthermore, as described above, as secondary pressure vessel 400 is integrally coupled to primary pressure vessel 202, there is no need for cladding step between primary pressure vessel 202 and secondary pressure vessel 400.

Here, secondary pressure vessel 400 is an exemplary annulus wing vessel comprising body 402 comprising first fixture 404 and second fixture 406 and representing a replacement to wing block 300 depicted in FIG. 3A-3B. It should be understood that annulus wing vessel is exemplary and represents any undersea oil and gas pressure vessel that may be manufactured by additive manufacturing and integrally coupled to primary pressure vessel 202, which may be any other undersea oil and gas system component. Again, the primary pressure vessel 202 and secondary pressure vessel 400 described herein may be any component associated with an undersea tree, manifold (e.g., Pipeline End Manifold PLEM), Pipeline End Termination (PLET), primary control block, secondary control block, and any other standard flow control components in the industry. Furthermore, secondary pressure vessel 400 is produced through the AM process described herein and can be customizable to any shape and size and include any arrangement of conduits and cavities for controlling the flow of fluid allowable by the AM processes.

Furthermore, an alternative configuration of secondary pressure vessel 400 is depicted in FIG. 5A. However, it should be understood that any geometry of secondary pressure vessel 400 may be provided including secondary conduits (e.g., channel 416 and fixture conduits 410, 414) and secondary valve cavities 418, 420 to control the flow of fluid through secondary pressure vessel 400. Alternative geometries are discussed in detail below.

FIG. 4A-4B depict secondary pressure vessel 400 including various conduits for channeling fluid therethrough. Here, secondary pressure vessel 400 comprises first fixture 404 comprising first fixture conduit 410 and first attachment points 408, second fixture 406 comprising second fixture conduit 414 and second attachment points 412, and channel 416 providing a path between first fixture 404 and second fixture 406. Furthermore, in some embodiments, secondary pressure vessel 400 may comprise first valve cavity 418 and second valve cavity 420 configured to house valves for controlling the flow of the fluid through secondary pressure vessel 400. Illustrated here, fixtures 404, 406 provide attachments points 408, 412 for coupling various other components such as, for example, pressure vessels, pipes, tubes, valves, and the like. Here, two fixtures are provided; however, there may be a single fixture or more than two. For example, FIG. 6A depicts a configuration of secondary pressure vessel 400 comprising channel 416 and a single fixture comprising a single conduit and a single corresponding valve. As such, any conduits exiting primary pressure vessel 202 into channel 416 may provide fluid between various primary conduits and/or through the single conduit. Similarly, or alternatively, secondary pressure vessel 400 may provide conduits without attachment points. Furthermore, in some embodiments, fixtures 404, 406 may comprise a plurality of conduits configured to provide fluid to a plurality of attachment pipes, tubes, valve blocks, and the like. Furthermore, a plurality of fixtures may be provided.

In some embodiments, fixtures 404, 406 may provide couplings for valves disposed in valve cavities 418, 420. As such, attachment points 408, 412 and fixture conduits 410, 414 may be configured for attaching and controlling valves housed within valve cavities to allow fluid to flow through channel 416. Furthermore, in some embodiments, fixture conduits 410, 414 may be configured to allow fluid to flow therethrough when valves disposed in valve cavities 418, 420 are open. As such, the flow of fluid through secondary pressure vessel 400 may be controlled to flow through any conduit. Furthermore, various other conduits may be provided as described in more detail below.

In some embodiments, a size and a shape of fixture conduits 410, 414 and channel 416 may be based on various fluid characteristics such as, for example, viscosity, temperature, density, and the like. Furthermore, the size and shape may be based on flow characteristics such as pressure, flowrate, flow type, and the like. Generally, the shape of fixture conduits 410, 414 is round and channel 416 is triangular; however, the shapes illustrated here are exemplary and may be oval, square, triangular, or any irregular shape depending on the desired flow characteristics and the fluid characteristics.

In some embodiments, the configuration of fixtures 404, 406 may be determined by function and devices to which fixtures 404, 406 can be coupled. As shown, first fixture 404 comprises a square cross section and four attachment points 408 and second fixture 406 comprises a circular cross section and six attachment points 412. The shapes provided here are exemplary and any regular or irregular shape may be provided by fixtures 404, 406 based on tubes, hoses, and valves that may be attached thereto. Furthermore, any number, shape, and type of attachment points 408, 412 may be provided. Here, attachment points 408, 412 are bolt holes. Attachment points 408, 412 may be any shape and size and may be configured to attach various attachments such as, screws, rivets, and the like. Furthermore, fixtures 404, 406 may comprise threads to which the other components described above may be threaded onto. In some embodiments, the threads may be added post manufacturing.

Here, secondary pressure vessel 400 comprises channel 416. Channel 416 may provide fluid connectivity between first fixture 404 and second fixture 406. Furthermore, channel 416 may provide fluid connectivity between various primary conduits (e.g., primary conduits 310, 312, and 314) exposed to secondary pressure vessel 400. Here, channel 416 is configured to receive fluid from primary conduits 310, 312, 314 and provide the fluid between primary conduits 310, 312, 314 and/or fixtures 404, 406 based on the valve configurations provided in primary pressure vessel 202 and secondary pressure vessel 400. Here, secondary pressure vessel 400 comprises two potential conduits and primary pressure vessel 202 comprises three conduits; however, the quantities provided herein are exemplary and any number of conduits may be provided.

In an exemplary embodiment, secondary pressure vessel 400 may provide an annulus pressure vessel. Here, fluid may build up in an annulus of a borehole of the oil and gas well and the fluid may be released through primary pressure vessel 202 and through secondary pressure vessel 400 providing annulus fluid conduits and valves to remove the annulus fluid. Furthermore, in some embodiments, secondary pressure vessel 400 may be an exemplary production wing block providing fluid conduits to allow production fluid to flow therethrough. Again, the production fluid conduits may allow production fluid to flow from the primary pressure vessel 202 through secondary pressure vessel 400 and up through the production piping of the oil and gas system. Cross sections are shown in FIG. 6A-6B illustrating various interconnected conduits of primary pressure vessel 202 and secondary pressure vessel 400.

FIG. 5A-5C depict pressure containment vessel 500 in various stages of manufacturing secondary pressure vessel 400 on primary pressure vessel 202 by the additive manufacturing process and system shown in FIG. 1 and described above. Furthermore, as in the description above and illustrated in FIGS. 4A and 4B, secondary pressure vessel 400 depicted in FIG. 5A-5C can be a customized for a third-party ordering a component that, because of the AM processes described herein, only comprises necessary components. FIG. 5A depicts secondary pressure vessel 400 manufactured on surface 602 of primary pressure vessel 202 at integrally coupled surface 504. Though an annulus pressure vessel is shown, it should be understood that any device may be integrally formed with primary pressure vessel 202. Furthermore, surface 602 of primary pressure vessel 202 may be any geometry that may be stored in memory 124 and is not limited to a flat surface.

In some embodiments, primary pressure vessel 202 may be provided on AM system 100 and prepared for manufacturing secondary pressure vessel 400. For example, the surface 602 of primary pressure vessel 202 may be cleaned using chemicals and/or any other cleaning process. Furthermore, in some embodiments, the surface 602 may be smoothed to remove any defects that could reflect through the layers of secondary pressure vessel 400.

Once surface 602 is cleaned and prepared for manufacturing, primary pressure vessel 202 may be provided in AM system 100 as illustrated in FIG. 1. The first layer of secondary pressure vessel 400 may be applied, as described above, by providing material (e.g., material 108) on surface 602 of primary pressure vessel 202. Nozzle 116 may then be provided to melt the metal material 108 and the surface 602 of primary pressure vessel 202 integrally forming secondary pressure vessel 400 with primary pressure vessel 202 surface 602 to create an integrally formed part. Nozzle 116 may trace each successive cross section (e.g., layer) of secondary pressure vessel 400 from surface 602 up, forming secondary pressure vessel 400 layer by layer. FIG. 5A depicts the first few layers of secondary pressure vessel 400 integrally formed on surface 602 of primary pressure vessel 202.

FIG. 5B depicts secondary pressure vessel 400 with a few more layers added than illustrated in FIG. 5A. Again, Nozzle 116 traces the cross section of secondary pressure vessel 400 at each successive layer forming secondary pressure vessel 400 from the material 108 in the exemplary DED method described above. Here, each layer deposits material for secondary pressure vessel 400 while leaving an absence of material across the channel 416, valve cavities 418, 420, and fixture conduits 410, 414. As such, the channel 416, valve cavities 418, 420, and fixture conduits 410, 414 can be formed in line with primary conduits 310, 312, and 314 of primary pressure vessel 202.

FIG. 5C depicts primary pressure vessel 202 fully integrally coupled to secondary pressure vessel 400. As described here, primary pressure vessel 202 is integrally formed with secondary pressure vessel 400. In some embodiments, as described above, secondary pressure vessel 400 may be additively manufactured separately from primary pressure vessel 202 and welded to surface 602 of primary pressure vessel 202.

Furthermore, in some embodiments, secondary pressure vessel 400 may comprise one or more materials, by having multiple material 108 options alternated at each position through the feeder control of nozzle 116. Secondary pressure vessel 400 may comprise a plurality of metals either mixed to create an alloy or separate such that different parts, or components, comprise different materials and may be customizable upon order from the third-party. For example, as shown in FIG. 5C, body 402 may comprise a first material, first fixture 404 may comprise a second material, and second fixture 406 may comprise a third material. In some embodiments, a single component may be different materials. For example, body 402 may comprise the first material near primary pressure vessel 202 and second material near fixtures 404, 406. In some embodiments, the materials may be any material suitable for undersea systems described herein such as, for example, steel, low alloy steel, nickel alloys such as Inconel, stainless steel, and the like.

FIG. 6A depicts primary pressure vessel 202 integrally coupled to secondary pressure vessel 400. Here, secondary pressure vessel 400 comprises channel 416 connecting primary conduits 310, 312, and 314 with fixtures 404, 406 of secondary pressure vessel 400. Here, and as shown in FIG. 6B, several primary pressure vessel conduits may be exposed to channel 416 allowing various fluids to flow between the annulus of the well and the annulus tubing of the main well bore. As such, valves may be provided in primary valve cavities (shown in FIG. 3B) interior to primary pressure vessel 202 and may be actuated to provide each of the various fluids to and from channel 416. Furthermore, in some embodiments, fixtures 404, 406 may provide secondary valve cavities 418, 420 for controlling the flow of fluid through various primary conduits, channel 416, and secondary conduits (e.g., channel 416, fixture conduits 410, 414, and secondary valve cavities 418, 420).

FIG. 6B depicts an exemplary cross section of primary pressure vessel 202 and secondary pressure vessel 400. In some embodiments, it may be necessary to provide one or more fixtures 404, 406 to secondary pressure vessel 400 as described in embodiments above. As such, two, three, four, or additional fixtures may be integrally manufactured to the surface 602 of primary pressure vessel 202.

Furthermore, there is only a single channel 416 depicted in FIGS. 6A and 6B; however, it should be understood that channel 416 is exemplary, and any number and arrangement of channels may be provided. For example, channel 416 may be a first channel. At second fixture 406, a second channel extending at a 90-degree angle to channel 416 may also be provided. Furthermore, a third channel may be provided and connected to second channel or a third fixture. In some embodiments, channels may be configured in any arrangement that may provide the necessary function of secondary pressure vessel 400 integrally coupled to primary pressure vessel 202. Furthermore, the cross section of channels may be any shape, any length, and may follow curved paths as described above.

FIG. 6C illustrate a general geometry of secondary pressure vessel 400. Here, secondary pressure vessel 400 is a customized component created by DED AM as described above. Pressure vessel 400 does not include components that are only necessary in typical mechanically assembled interfaces (e.g., flanges, seals, and the like). FIG. 6C illustrates that, using the AM techniques described herein, secondary pressure vessel 400 can include tight curves 606, corners 604, changes in cross sectional area 608, and various pipe shapes (e.g., circular, square, rectangular, triangular, or any other standard or irregular shape) including cavities 203. These features not capable of being bored around corners in standard manufacturing techniques. As such, the AM manufacturing of the pressure vessels described herein eliminate prost processing and addition of the unnecessary components described above.

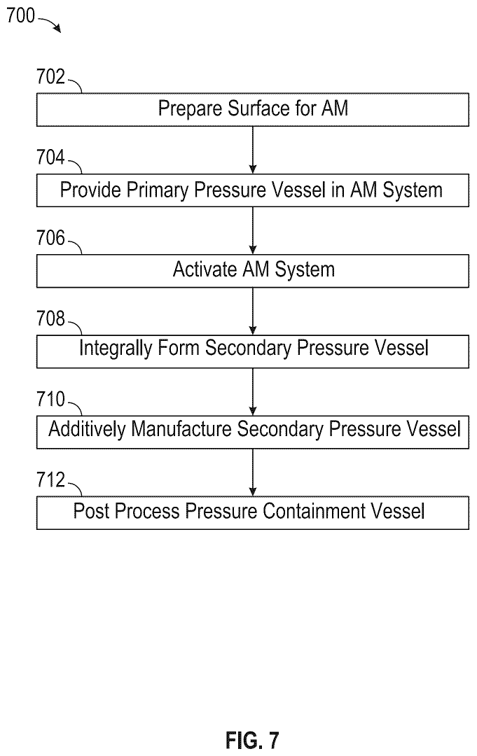

FIG. 7 depicts a flow chart illustrating a method 700 of additively manufacturing secondary pressure vessel 400 for the undersea tree of the undersea oil and gas well described in embodiments above. As described above, secondary pressure vessel 400 may be additively manufactured and integrally coupled to primary pressure vessel 202. In some embodiments, secondary pressure vessel 400 may be manufactured separately and welded to primary pressure vessel 202, and, in some embodiments, secondary pressure vessel 400 may be manufactured directly onto (integrally formed with) primary pressure vessel 202.

At step 702, surface 602 of primary pressure vessel 202 is prepared for manufacturing. Here, surface may be cleaned and smoothed to create an optimal surface for additive manufacturing. In some embodiments, the surface may be cleaned with chemicals, and the like to prevent contaminates that could cause defects in the additive manufacturing layers.

At step 704, primary pressure vessel 202 may be placed into AM system 100. Primary pressure vessel 202 may be placed on build platform 104 and secured such that the geometry and location of surface 602 and the starting point of the additive manufacturing process is known and stored in memory 136. Though, the sequence of steps described here lists surface preparation before placement of primary pressure vessel 202, it should be understood that the sequence of events is optional.

At step 706, AM system 100 may be activated with computer-executable instructions indicative of the geometry of secondary pressure vessel 400 and providing control of the Nozzle 116 to generate AM layers of the secondary pressure vessel 400. At step 708, the first layer of secondary pressure vessel 400 is integrally formed with surface 602 of primary pressure vessel 202. Material 108 may be deposited on surface 602 to melt surface 602 and material 108 to form the first layer of secondary pressure vessel 400 with surface 602.

At step 710, Nozzle 116 is controlled to form each subsequent layer of secondary pressure vessel 400 integrally formed with primary pressure vessel 202. AM system 100 may be controlled to form secondary conduits (e.g., channel 416, valve cavities 418, 420, and fixture conduits 410, 414, aligned with primary conduits 310, 312, 314. Furthermore, in each conduit may be provided one or more valve cavities 418, 420 configured for receiving valves therein. Furthermore, valve insertion conduits may be created adjacent to the valve cavities for inserting valves into the valve cavities 418, 420 after completion of the additive manufacturing process.

At step 712, post processing is performed on the combined pressure containing vessel including primary pressure vessel 202 and secondary pressure vessel 400. In some embodiments, post processing includes cutting, grinding, boring, drilling, finishing, etching, polishing, heat treating, treating and the like. In some embodiments, post processing comprises adding valves to valve cavities and conduits by way of the valve insertion conduits. Furthermore, any gaskets may be provided securing valves in place and preventing leaking of the fluids running through secondary pressure vessel 400. In some embodiments, post processing including adding material by additive manufacturing to seal the valve insertion conduits and/or any other holes or defects in secondary pressure vessel 400.

In some aspects, the techniques described herein relate to a pressure containment vessel of an oil and gas well.

In some aspects the techniques described herein relate to a primary pressure vessel, including at least one primary fluid conduit and one or more valves configured to control a flow of fluid in the primary pressure vessel.

In some aspects, the techniques described herein relate to a secondary pressure vessel integrally coupled to the primary pressure vessel, wherein the secondary pressure vessel is formed by additive manufacturing, wherein the secondary pressure vessel includes at least one secondary fluid conduit in fluid communication with the at least one primary fluid conduit.

In some aspects, the techniques described herein relate to a pressure containment vessel, wherein the primary pressure vessel is a primary valve block of a subsea tree, manifolds, or pipeline end termination of undersea oil and gas well systems.

In some aspects, the techniques described herein relate to a pressure containment vessel, further including at least one valve cavity configured for housing a valve to control the fluid to flow through the secondary pressure vessel.

In some aspects, the techniques described herein relate to a pressure containment vessel, further including a channel providing the at least one valve cavity in fluid communication with the at least one primary fluid conduit.

In some aspects, the techniques described herein relate to a pressure containment vessel, wherein the secondary pressure vessel is welded to a surface of the primary pressure vessel aligning the at least one primary fluid conduit with the at least one secondary fluid conduit.

In some aspects, the techniques described herein relate to a pressure containment vessel, wherein the secondary pressure vessel is integrally formed with a surface of the primary pressure vessel by the additive manufacturing, and wherein the secondary pressure vessel is customized based on an order from a third-party.

In some aspects, the techniques described herein relate to a pressure containment vessel, wherein the additive manufacturing is direct energy deposition, and wherein the secondary pressure vessel includes at least two different materials.

In some aspects, the techniques described herein relate to a pressure containment vessel, wherein the secondary pressure vessel is integrally coupled to the primary pressure vessel, wherein the coupling does not include cladding.

In some aspects, the techniques described herein relate to a pressure containment vessel of an oil and gas well including: a primary pressure vessel, including: at least one primary fluid conduit; and one or more valves configured to control a flow of fluid in the primary pressure vessel; a secondary pressure vessel integrally coupled to the primary pressure vessel, wherein the secondary pressure vessel is formed by additive manufacturing, the secondary pressure vessel including: at least one secondary fluid conduit in fluid communication with the at least one primary fluid conduit; and at least one valve cavity configured for housing a valve to control the fluid to flow through the secondary pressure vessel.

In some aspects, the techniques described herein relate to a pressure containment vessel, further including a channel providing the at least one valve cavity in fluid communication with the at least one primary fluid conduit.

In some aspects, the techniques described herein relate to a pressure containment vessel, wherein the oil and gas well is an undersea oil and gas well, and wherein the primary pressure vessel is a primary valve block.

In some aspects, the techniques described herein relate to a pressure containment vessel, wherein the secondary pressure vessel is an annulus wing block.

In some aspects, the techniques described herein relate to a pressure containment vessel, wherein the secondary pressure vessel is welded to a surface of the primary pressure vessel aligning the at least one primary fluid conduit with the at least one secondary fluid conduit.

In some aspects, the techniques described herein relate to a pressure containment vessel, wherein the secondary pressure vessel is integrally formed with a surface of the primary pressure vessel by the additive manufacturing.

In some aspects, the techniques described herein relate to a pressure containment vessel, wherein the additive manufacturing is direct energy deposition.

In some aspects, the techniques described herein relate to a method of additively manufacturing a pressure containment vessel for an undersea oil and gas well, the method including: providing a primary pressure vessel in an additive manufacturing device, wherein the primary pressure vessel includes primary fluid conduits exposed to a surface of the primary pressure vessel; providing a material to the surface of the primary pressure vessel; melting the material with the surface to generate a first layer of a secondary pressure vessel integrally formed with the primary pressure vessel; and generating subsequent layers to create the secondary pressure vessel including secondary fluid conduits in fluid communication with the primary fluid conduits.

In some aspects, the techniques described herein relate to a method, further including generating at least one valve cavity in the secondary pressure vessel, the at least one valve cavity configured to house at least one valve to control flow of a fluid through the secondary pressure vessel.

In some aspects, the techniques described herein relate to a method, wherein the primary pressure vessel is a primary valve block of the undersea oil and gas well.

In some aspects, the techniques described herein relate to a method, further including forming at least two fixtures each fixture of the at least two fixtures including a conduit configured to allow the fluid to flow therethrough.

In some aspects, the techniques described herein relate to a method, further including forming a channel connecting the at least two fixtures and the primary fluid conduits, wherein the channel is non-linear and optimized for efficient fluid flow.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. A pressure containment vessel of an oil and gas well comprising:
a primary pressure vessel, comprising:
at least one primary fluid conduit; and
one or more valves configured to control a flow of fluid in the primary pressure vessel;
a secondary pressure vessel integrally coupled to the primary pressure vessel, wherein the secondary pressure vessel is formed by additive manufacturing,
wherein the secondary pressure vessel comprises at least one secondary fluid conduit in fluid communication with the at least one primary fluid conduit.

2. The pressure containment vessel of claim 1, wherein the primary pressure vessel is a primary valve block of a subsea tree, manifolds, or pipeline end termination of undersea oil and gas well systems.

3. The pressure containment vessel of claim 2, further comprising at least one valve cavity configured for housing a valve to control the fluid to flow through the secondary pressure vessel.

4. The pressure containment vessel of claim 3, further comprising a channel providing the at least one valve cavity in fluid communication with the at least one primary fluid conduit.

5. The pressure containment vessel of claim 1, wherein the secondary pressure vessel is welded to a surface of the primary pressure vessel aligning the at least one primary fluid conduit with the at least one secondary fluid conduit.

6. The pressure containment vessel of claim 1,
wherein the secondary pressure vessel is integrally formed with a surface of the primary pressure vessel by the additive manufacturing, and
wherein the secondary pressure vessel is customized based on an order from a third-party.

7. The pressure containment vessel of claim 6,
wherein the additive manufacturing is direct energy deposition, and
wherein the secondary pressure vessel comprises at least two different materials.

8. The pressure containment vessel of claim 1, wherein the secondary pressure vessel is integrally coupled to the primary pressure vessel, wherein the coupling does not include cladding.

9. A pressure containment vessel of an oil and gas well comprising:
a primary pressure vessel, comprising:
at least one primary fluid conduit; and
one or more valves configured to control a flow of fluid in the primary pressure vessel;
a secondary pressure vessel integrally coupled to the primary pressure vessel,
wherein the secondary pressure vessel is formed by additive manufacturing,
the secondary pressure vessel comprising:
at least one secondary fluid conduit in fluid communication with the at least one primary fluid conduit; and
at least one valve cavity configured for housing a valve to control the fluid to flow through the secondary pressure vessel.

10. The pressure containment vessel of claim 9, further comprising a channel providing the at least one valve cavity in fluid communication with the at least one primary fluid conduit.

11. The pressure containment vessel of claim 9,
wherein the oil and gas well is an undersea oil and gas well, and
wherein the primary pressure vessel is a primary valve block.

12. The pressure containment vessel of claim 11, wherein the secondary pressure vessel is an annulus wing block.

13. The pressure containment vessel of claim 11, wherein the secondary pressure vessel is welded to a surface of the primary pressure vessel aligning the at least one primary fluid conduit with the at least one secondary fluid conduit.

14. The pressure containment vessel of claim 11, wherein the secondary pressure vessel is integrally formed with a surface of the primary pressure vessel by the additive manufacturing.

15. The pressure containment vessel of claim 14, wherein the additive manufacturing is direct energy deposition.

16. A method of additively manufacturing a pressure containment vessel for an undersea oil and gas well, the method comprising:
providing a primary pressure vessel in an additive manufacturing device,
wherein the primary pressure vessel comprises primary fluid conduits exposed to a surface of the primary pressure vessel,
wherein the primary fluid conduits comprise one or more primary valves configured to control a flow of fluid in the primary pressure vessel;
providing a material to the surface of the primary pressure vessel;
melting the material with the surface to generate a first layer of a secondary pressure vessel integrally formed with the primary pressure vessel; and
generating subsequent layers to create the secondary pressure vessel including secondary fluid conduits in fluid communication with the primary fluid conduits.

17. The method of claim 16, further comprising generating at least one valve cavity in the secondary pressure vessel, the at least one valve cavity configured to house at least one valve to control the flow of the fluid through the secondary pressure vessel.

18. The method of claim 17, wherein the primary pressure vessel is a primary valve block of the undersea oil and gas well.

19. The method of claim 18, further comprising forming at least two fixtures each fixture of the at least two fixtures comprising a conduit configured to allow the fluid to flow therethrough.

20. The method of claim 19, further comprising forming a channel connecting the at least two fixtures and the primary fluid conduits, wherein the channel is non-linear and optimized for efficient fluid flow.
